(19) United States
(12) Patent Application Publication
(10) Pub. No.: US 2006/0102672 A1
(43) Pub. Date: May 18, 2006

(54) Multiple bag carry strap

(75) Inventor: Donald E. Godshaw, Evanston, IL (US)

Correspondence Address: BANNER & WITCOFF, LTD., TEN SOUTH WACKER DRIVE, SUITE 3000, CHICAGO, IL, 60606, US

(73) Assignee: Travel Caddy, Inc. d/b/a Travelon, Des Plaines, IL (US)

(21) Appl. No.: 10/986,618

(22) Filed: Nov. 12, 2004

(51) Int. Cl. A45C 3/00; B60R 11/00

(52) U.S. Cl. 224/572; 190/108

(57) ABSTRACT

A carry strap for simultaneously supporting three luggage items includes a strap member attachable to a first wheeled luggage item, a second flexible strap which supports a second luggage item and a third flexible strap which connects from the second strap to a third luggage item.

### BACKGROUND OF THE INVENTION

In a principal aspect, the present invention comprises a carry strap for baggage or luggage which is capable of simultaneous cooperation and thus use with three items of luggage so that those three items may be carried and transported easily together as a unit.

Movement of luggage when traveling, especially airline travel, is often challenging because of multiple pieces of cumbersome luggage which must be transported. That is, very often, multiple pieces of luggage must be simultaneously transported by a single person. Carrying two or more pieces of luggage is, for many, a difficult undertaking.

Currently, there are available luggage items such as carry-ons and larger luggage items which include wheels and a telescoping handle to facilitate luggage movement. Further, it is generally common to have a short strap which will attach to the handle or a post of a first luggage item to a second luggage item so that the luggage items may be bundled together.

Nonetheless, there remains the difficult problem of how to handle or move more than two luggage items. For example, pulling two luggage items which are bundled together in the manner described above plus carrying a further suitcase, valise, or the like, remains a difficult problem. Thus, an improved method or means to move multiple pieces of luggage by a single individual in a compact, easily accessible, easily usable manner is desired. These objectives, among others, have inspired the development of the luggage carry strap of the invention.

### SUMMARY OF THE INVENTION

Briefly, the present invention comprises a carry strap which can be used to carry at least three items of luggage in a unitary or bundled manner with those items of luggage, in effect, stacked or juxtaposed one against the other and wherein one of the luggage items, which includes a telescoping handle and wheels, may be relied upon to support and transport the other luggage items. The carry strap includes a clamshell type attachment, clasp or clip for attachment to the luggage item which includes the telescoping handle and wheels. The clasp is attached by means of a first, adjustable strap to a second luggage item stacked against the wheeled luggage item. A ring member is provided for the first flexible strap. A second flexible strap is attached by means of an adjustable buckle to the ring member. The second adjustable strap may then be engaged with the handle of a further or third luggage item stacked against the other two luggage items in the array. Additional strap members may be incorporated in a similar fashion so that more than three luggage items may be stacked one upon the other and wherein all of the luggage items are arrayed in a manner which promotes their stability, yet enables a single, wheeled, telescoping handle luggage item to serve as the platform and carrying vehicle for the assembled items of luggage.

Thus, it is an object of the invention to provide an improved carry strap for the simultaneous carriage of multiple items of luggage.

It is a further object of the invention to provide a luggage carry strap which includes a series of flexible straps associated with adjustable buckles to enable adjustment of the length of the various connected straps and thereby accommodate luggage items of various sizes.

Another object of the invention is to provide a carry strap device which includes a clamp or clasp that can be used to releasably attach the carry strap construction to a wheeled luggage item.

Another object of the invention is to provide a lightweight, yet structurally strong and highly flexible carry strap for use in association with three luggage items simultaneously so as to enable the simultaneous carriage of those three items in a packed array by a single person in an efficient manner wherein the balanced or stacked luggage items are maintained in a stable condition for movement or transport.

Another object of the invention is to provide a carry strap which is inexpensive, rugged, easy to use and which can accommodate luggage items of numerous sizes and configurations.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of the carry strap of the invention as it is utilized to support three separate and uniquely shaped and constructed items of luggage;

FIG. 2 is an isometric view of the carry strap construction utilized in the embodiment and in the manner depicted in FIG. 1;

FIG. 3 is an alternate construction of the carry strap of the invention;

FIG. 4 is a diagrammatic view of a version of the strap of the invention; and

FIG. 5 is a diagrammatic view of an alternative version of the strap of the invention.

### DESCRIPTION OF THE PREFERRED EMBODIMENT

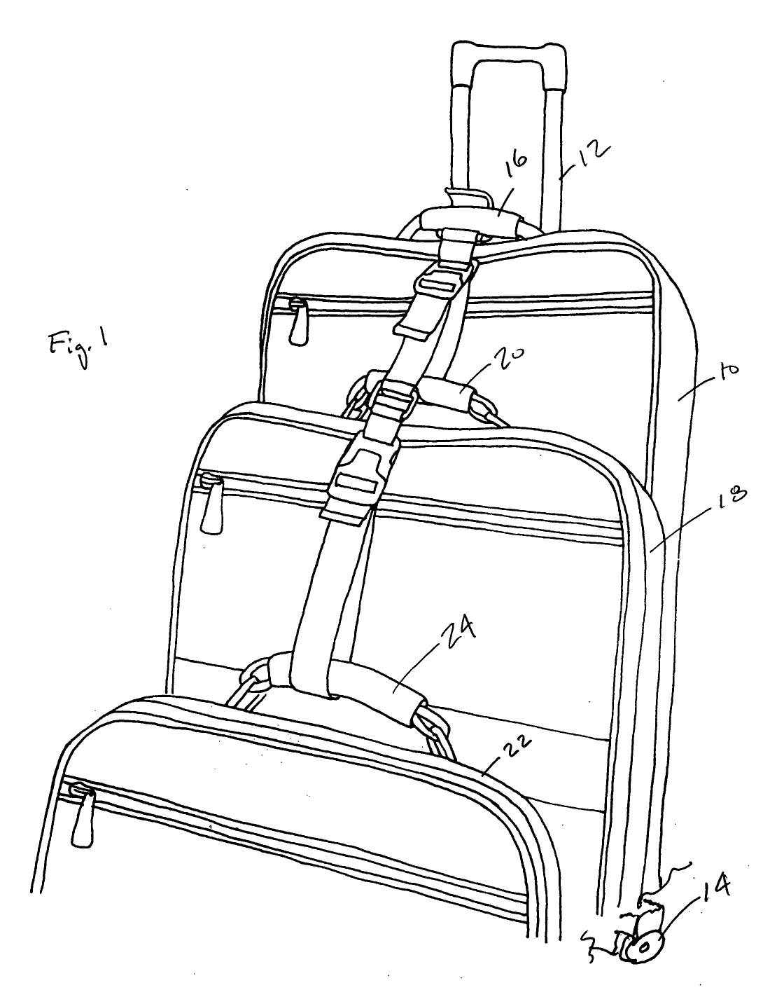

Referring to FIG. 1, typical luggage items which benefit from the use of the present invention are illustrated in combination with the luggage strap of the invention. A wardrobe sized luggage item 10 having a telescoping handle 12 and wheels, such as wheels 14, is provided with a carry handle 16 at its upper end. A second luggage item 18, which does not necessarily include a telescoping handle or wheels but does include a carry handle 20, may be positioned and maintained in position or stacked against the first luggage item 10 by utilization of the present invention. A third luggage item 22 of another size, for example, the size of a valise, may or may not include a telescoping handle. The third item 22 does include a carry handle 24 or an equivalent structure to a carry handle 24. The third item of luggage 22 is stacked and held in position against the second item 20. Although there are luggage items of various sizes in FIG. 1, the invention accommodates luggage items which may be similarly sized as well as luggage items having different shapes, configurations, thicknesses and the like. Preferably, however, at least one of the luggage items includes a telescoping handle such as the first luggage item 10, and further includes wheels, such as wheels 14, to enable the more efficient use of the separate carry strap of the invention.

A function of the carry strap of the invention is to couple the various luggage items 10, 18 and 22 in a manner which enables them to be appropriately balanced and arrayed so that they can be easily moved and carried merely by extending the telescoping handle 12 and moving the assembly on the rollers or wheels 14. Thus, the carry strap is comprised of flexible strap members and adjustable buckle elements or buckles which coact with the handles 16, 20 and 24 (or equivalent) so as to facilitate the functional objectives.

The carry strap of the invention includes a clamp member or handle clasp 30 which, in a preferred embodiment, is comprised of a first shell-shaped or rigid arcuate member 32 such as manufactured from a molded plastic material joined by a pivot pin or hinge 34 to a second clasp member 36 which in a preferred embodiment is generally arcuate. However, the clasp members 32, 36 may be made from metal, metal wire, and may or may not include a pivot connection. Thus, numerous types of clasp members or handle clasps may be utilized in the practice of the invention.

A first flexible strap 38 is joined to the clasp 30 at a first end 40. The flexible strap 38 is preferably an inch or two in width. In the preferred embodiment the first flexible strap 38 is sewn to or attached to a ring member 42 at the end 41 distal from the first end 40 connected to the clasp 30. The ring member 42 may be a metal ring or a molded plastic ring, or some other type of material may be used to make the ring member 42. In the preferred embodiment, the ring member 42 is a generally rectangular ring member with a width slightly greater than the width of the strap 38.

A second flexible strap 44 includes a first end 46 which is attached to a buckle element 48. The attachment of the first end 46 to the buckle element 48 is adjustable inasmuch as the first end 46 may be adjusted in length through the element 48. The second strap 44 is fitted through a second ring element 50 similar in size, shape and construction to the first ring element 42. The second strap 44 may be fitted around a leg 52 of the ring element 50 and sewn by stitching 54 so as to be fixed to the ring element 50. Alternatively, the second strap 44 may slidably pass through the ring 50.

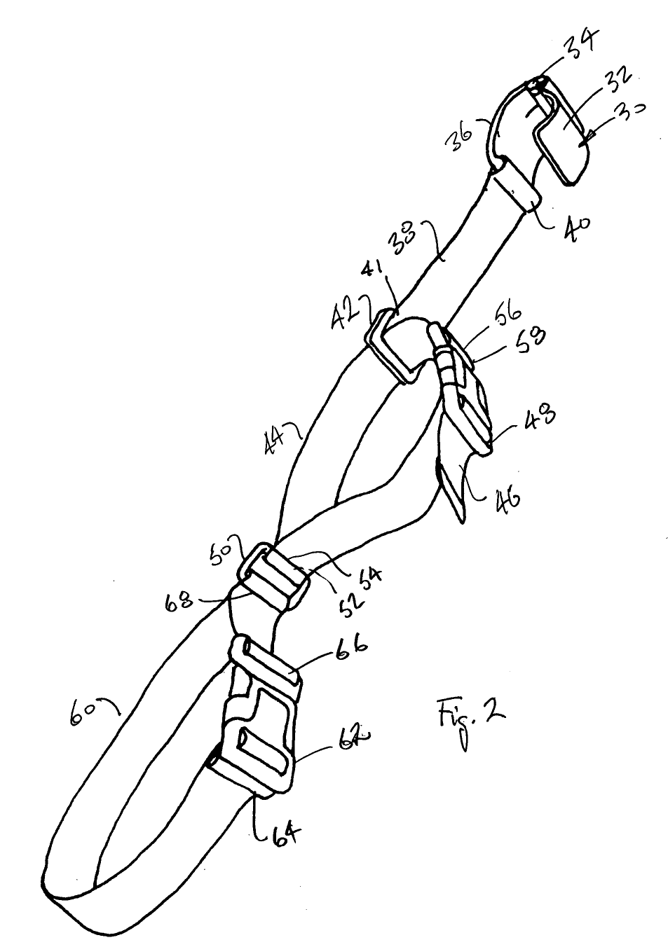

The second strap 44 also is passed through the ring 42 as depicted, for example, in FIG. 2. Again, the second strap 44 may be sewn in the manner depicted with respect to the ring 50 or slidably passed through the ring 42.

The second end of the second strap 44; namely, the second end 56 is attached to a second buckle element 58. The attachment to the second buckle element 58 may be adjustable or non-adjustable. In any event, the distance between the ring elements 42 and 50 is adjustable by means of the cooperative relationship between strap 44 and adjustable buckle elements 48 and/or 50. In other words, numerous alternative connections may be effected between the rings 42 and 50 by means of flexible second strap 44 to accommodate the concept and functionality of adjustment of the distance between the rings 42 and 50. For example, it is not necessary that each of the ends 46 and 56 be adjustably connected to a respective buckle member or element 48, 58. Only one of those ends 46, 56 need be adjustable. Various other interconnections of the rings 42 and 50 via the strap 44 and the adjustable buckle element 48 may be effective to adjust the distance between the rings 42 and 50.

In a similar fashion, a third flexible strap 60 is connected to the ring member 50 as well as to an adjustable buckle 62. The opposite ends of the third strap 60; namely, a first end 64 and second end 66 may be adjusted in order to adjust the effective length of the third flexible strap 60. Thus, the third flexible strap 60 may be sewn in place by means of a seam 68 to the ring element 50. Alternatively, the seam 68 may be omitted. Each of the first and second ends 64 and 66 may be attached to the adjustable buckle elements 64. Again, the effective length of the third flexible strap 60 is accommodated by means of the adjustable buckle 64 working in combination with one or both first and second ends 64 and 66 as well as the ring 50.

FIG. 2 depicts a preferred embodiment wherein the third flexible strap 60 is fixed to the ring 50 by means of the seam 68.

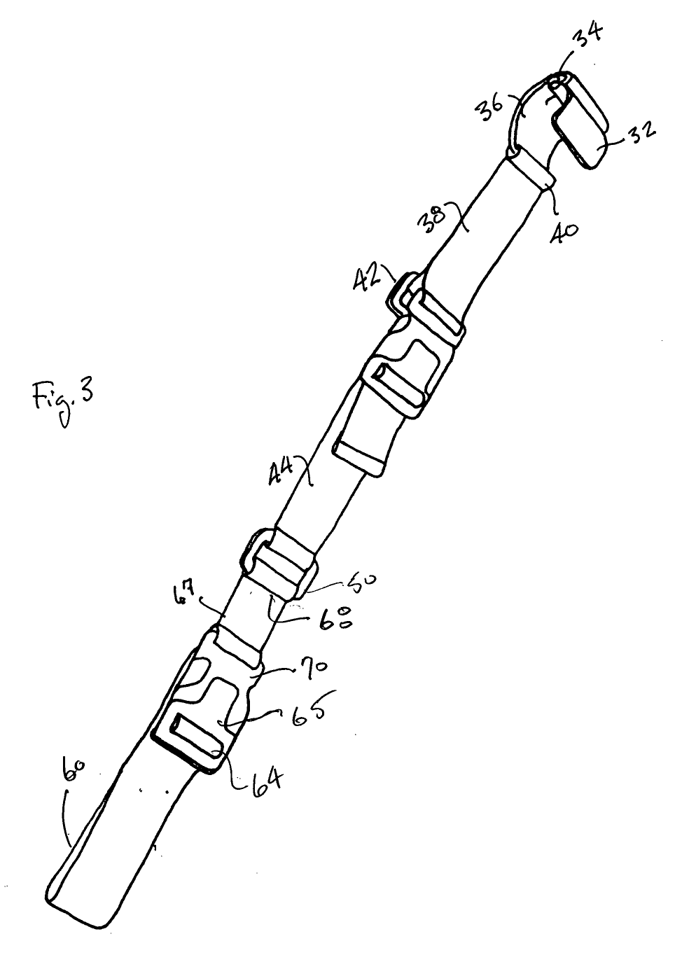

Referring to FIG. 3, an alternative arrangement is depicted wherein a first end 67 of the strap 60 feeds through a buckle element 70 and is then attached to ring 50 along a seam 68. Thus, the second end of the third strap 60; namely, second end 64 may be adjustably attached to the buckle element 65. Again, adjustment of the effective distance or length of the third flexible strap 60 is established by virtue of the coaction of the adjustable buckle 65 and its interaction with the flexible strap 60.

It should be noted that a strap may be a single continuous elongate web or may comprise elements which are joined one to the other through stitching or by other means to form a completed connection through ring members and through buckle mechanisms which are adjustably connected to the strap. Thus, the buckle mechanisms may have adjustment features associated with the separate elements comprising the buckle mechanism since a buckle mechanism typically will comprise first and second buckle member elements and each one of those separate buckle member elements will be separately attached to a belt member or strap member. Though each attachment may be adjustable, at least one of the attachments is preferred to be adjustable.

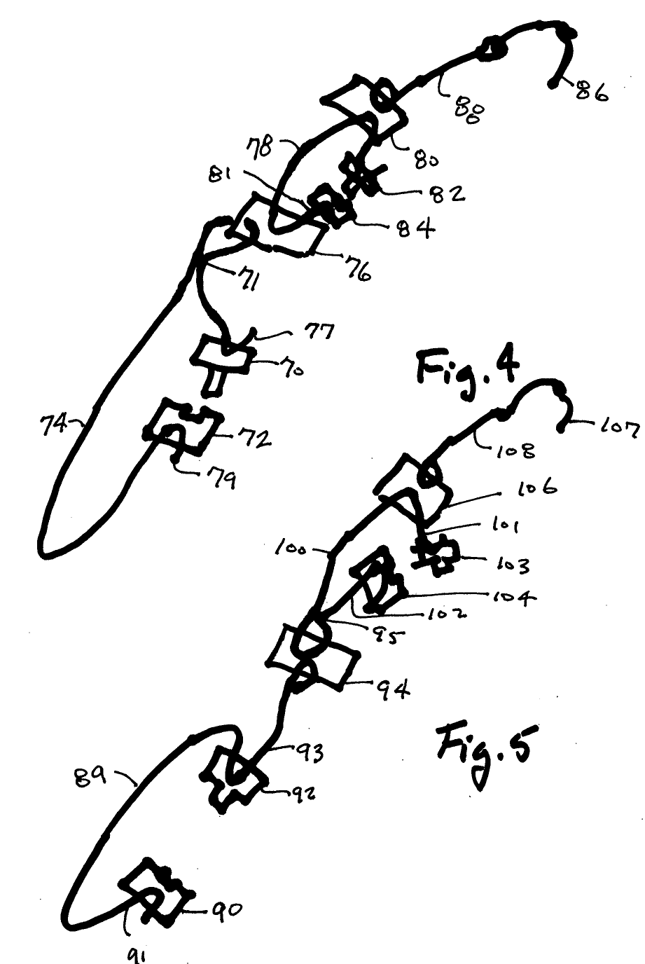

FIGS. 4 and 5 illustrate diagrammatically various arrangements of buckle members, straps and rings. In FIG. 4, for example, adjustable buckle elements 70 and 72 connect with opposite ends of a strap 74. The strap 74 passes through a ring 76 and is sewn in position along seam 71 with respect to the ring 76. One end 77 of the strap 74 connects to the adjustable buckle element 70. The other end 79 connects adjustably with element 72. Thus, in this embodiment, both of the buckle elements 70 and 72 are adjustably connected to a single strap 74. However, only one of the buckle elements needs to be so adjustable.

In FIG. 4, ring element 76 may coact with a strap 78 which, in turn, fits through a second ring element 80 and connects to an adjustable or non-adjustable buckle element 82. The opposite end 81 of the strap 78 connects to a second buckle element 84 which may or may not be adjustable. An attachment clasp 86 is attached by a strap 88 to ring 80. This is one arrangement of the connection of strap and buckle elements.

FIG. 5 illustrates a separate arrangement. In this second arrangement, a strap 89 is connected adjustably at one end 91 to a buckle element 90 and opposite end 93 fits through a second buckle element 92 in an adjustable fashion and further is connected by the end of the strap 89 to a ring 94. Thus, the end 93 is attached to the ring 94. A second strap 100 fits through ring 94 and is fixed thereto by virtue of a seam. The opposite ends 101, 102 of strap 100 cooperate adjustably with buckle elements 103, 104. End 101 is fitted through ring 106. Clasp 107 is attached by strap 108 to ring 106.

In use, as depicted in FIG. 1, the clasp 30 is positioned around the handle 16. The length of the second adjustable strap 44 is adjusted and the flexible buckle 48 is opened to permit attachment of strap 44 to the handle 20. The third strap 60 is similarly adjusted in length and attached to handle 24. As can be seen, therefore, the construction and adjustment of the carry strap of the invention may be effected in many distinct ways. Further, the construction of the buckle elements, the rings, the flexible straps, as well as the clasps, may all be varied and still considered within the scope of the invention. The invention is therefore limited only by the following claims and equivalents thereof.

What is claimed is:

1. A carry strap that is capable of simultaneous cooperation with at least three items of luggage for unitary transport thereof, each of said items including a top side carry handle, at least one of said items including a rolling transport feature, said strap comprising, in combination:
a handle clasp,
a first flexible strap having a first end and a second end, said first strap attached to the clasp at said first end;
a first ring element attached to said second end of the first strap;
a second flexible strap including a first end and a second end, said second strap ends each connected to a separate, releasable buckle element, one of said second strap ends adjustably connected to said connected, releasable buckle element, said second strap also attached to the first ring element and to a second ring element; and
a third flexible strap including a first end and a second end, said third strap ends each connected to a second releasable buckle element, one of said first and second ends of the third flexible strap adjustably connected to the second releasable buckle element, said third flexible strap attached to the second ring element whereby the effective length of a loop formed by each of the second and third straps is adjustable.

2. The strap of claim 1 wherein the handle clasp comprises a first rigid clamshell shaped member and a second clamshell shaped member, said first member pivotally attached to the second member, and one of said members attached to said first flexible strap.
